(19) United States
(12) Patent Application Publication
(10) Pub. No.: US 2001/0037372 A1
(43) Pub. Date: Nov. 1, 2001

(54) Data transfer system, and server and terminal adapter for use in data transfer system

(76) Inventors: Yorihito Tachi, Ikoma-shi (JP); Yasushi Shima, Osaka (JP); Shuichi Yoshikawa, Nara-shi (JP); Junji Tanaka, Sakurai-shi (JP)

Correspondence Address: BIRCH STEWART KOLASCH & BIRCH, PO BOX 747, FALLS CHURCH, VA, 22040-0747, US

(21) Appl. No.: 09/794,361

(22) Filed: Feb. 28, 2001

(30) Foreign Application Priority Data
Feb. 29, 2000 (JP) 2000-054805

(51) Int. Cl. G06F 15/16; G06F 15/173; G06F 17/00

(52) U.S. Cl. 709/217; 709/225; 235/375

(57) ABSTRACT

A data transfer system of the present invention includes a server and a terminal adapter capable of mutually transferring data to each other; the server accesses the terminal adapter at a prescribed dialing time, and determines an instruction for sending first data to the terminal adapter and an instruction for receiving second data from the terminal adapter so as to send the first data to the terminal adapter and receive the second data from the terminal adapter.

### BACKGROUND OF THE INVENTION

1. Field of the Invention

The present invention relates to a data transfer system, including a server and at least one terminal adapter interconnected to the server through a network and performing interactive data transfer, and to the server and the terminal adapter for use in the data transfer system.

2. Description of the Related Art

With the spread of the Internet, a variety of data transfer techniques using the Internet have been developed. For example, Japanese Laid-Open Publication No. 11-146011 discloses a configuration of a data transfer system in which an electronic mail (hereinafter, referred to as “e-mail”) is automatically distributed to a destination address thereof when an e-mail server receives the e-mail.

In the configuration of the data transfer system disclosed by Japanese Laid-Open Publication No. 11-146011, although an e-mail is automatically distributed from an e-mail server to a communication terminal, a user sending an e-mail is personally required to perform a transmission operation, such as a dial-up operation, etc., in order to send the e-mail to the e-mail server. Since the users can arbitrarily send e-mails, there is a possibility that the sending of e-mails may be concentrated in the e-mail server over a certain period of time.

Japanese Laid-Open Publication No. 4-124938 discloses a data transfer technique using polling.

In the configuration of the data transfer system disclosed by Japanese Laid-Open Publication No. 4-124938, a user is personally required to perform a transmission operation such as a dial-up operation, etc.

In the case where a terminal adapter is installed within a home and connected to a telephone line, an installation of the terminal adapter is limited to within reach of a telephone wire. Therefore, when the user uses the data transfer system, the user is required to take the trouble to go to a place where the terminal adapter is installed. In addition, it is inconvenient for the user to check whether the terminal adapter has received information, or for a child or an aged person to operate the terminal adapter.

### SUMMARY OF THE INVENTION

According to one aspect of the present invention, there is provided a data transfer system including a server and a terminal adapter capable of mutually transferring data to each other, in which the server accesses the terminal adapter at a prescribed dialing time, and determines an instruction for sending first data to the terminal adapter and an instruction for receiving second data from the terminal adapter so as to send the first data to the terminal adapter and receive the second data from the terminal adapter.

In one embodiment of this invention, the data transfer system allows a recording medium to be mountable thereon, and the instruction for sending the first data and the instruction for receiving the second data are issued based on whether the recording medium is mounted on the data transfer system or not.

In another embodiment of this invention, the dialing time is preset based on a data traffic of the server.

According to another aspect of the present invention, there is provided a data transfer system including a server and a plurality of terminal adapters capable of transferring data to each other, in which the server accesses each of the plurality of terminal adapters at a different dialing time preset for each of the plurality of terminal adapters, and determines an instruction for sending first data to each of the plurality of terminal adapters and an instruction for receiving second data from each of the plurality of terminal adapters so as to send the first data to each of the plurality of terminal adapters and receive the second data from each of the terminal adapters.

According to still another aspect of the present invention, there is provided a data transfer system including a server and a terminal adapter capable of mutually transferring data to each other, in which the terminal adapter accesses the server at a preset dialing time, and determines an instruction for sending first data to the server and an instruction for receiving second data from the server so as to send the first data to the server and receive the second data from the server.

In one embodiment of this invention, the terminal adapter has a wireless communication function, and determines, through the wireless communication, an instruction for sending first data to the server and an instruction for receiving second data from the server so as to send the first data to the server and receive the second data from the server.

According to still another aspect of the present invention, there is provided a terminal adapter capable of mutually transferring data to and from a server and allowing a recording medium to be mountable thereon, wherein the terminal adapter accesses the server at a preset dialing time based on whether the recording medium is mounted on the terminal adapter or not, and determines an instruction for sending first data to the server and an instruction for receiving second data from the server so as to send the first data to the server and receive the second data from the server.

In one embodiment of this invention, the terminal adapter has a wireless communication function, and determines, through the wireless communication, an instruction for sending first data to the server and an instruction for receiving second data from the server so as to send the first data to the server and receive the second data from the server.

In another embodiment of this invention, a dialing time and an address of the server are preset in the terminal adapter, and the terminal adapter accesses the server based on the preset dialing time and the preset address of the server.

In still another embodiment of this invention, a dialing time and an address of the server are preset in the recording medium, and the terminal adapter accesses the server based on the preset dialing time and the preset address of the server.

In still another embodiment of this invention, the dialing time is preset by accessing the server.

In still another embodiment of this invention, an address of the server is preset so that the terminal adapter automatically accesses the server in which the dialing time is preset.

According to still another aspect of the present invention, there is provided a server capable of mutually transferring data to and from a terminal adapter, in which the server accesses the terminal adapter at a preset dialing time, and determines an instruction for sending first data to the terminal adapter and an instruction for receiving second data from the terminal adapter so as to send the first data to the terminal adapter and receive the second data from the terminal adapter.

Thus, the invention described herein makes possible the advantages of providing (1) a data transfer system which does not require any specific operations for transferring data when sending/receiving data, and is capable of preventing data traffic from being concentrated; and (2) a server and a terminal adapter which are used in the data transfer system.

These and other advantages of the present invention will become apparent to those skilled in the art upon reading and understanding the following detailed description with reference to the accompanying figures.

### BRIEF DESCRIPTION OF THE DRAWINGS

FIG. 1 illustrates a configuration of a data transfer system 100 according to Example 1 of the present invention.

FIG. 2 illustrates the configuration of the data transfer system 100 according to Example 1 of the present invention in more detail.

FIG. 3 is a flowchart illustrating operations performed by a server 110 of the data transfer system 100 for center polling.

FIG. 4 is a flowchart illustrating operations by a terminal adapter 120 of the data transfer system 100 performed for the center polling.

FIG. 5 illustrates a configuration of a data transfer system 200 according to Example 2 of the present invention.

FIG. 6 is a flowchart illustrating operations performed by a terminal adapter 220 of the data transfer system 200 for a dialing time schedule registration.

FIG. 7 is a flowchart illustrating operations performed by a server 210 of the data transfer system 200 for the dialing time schedule registration.

FIG. 8 is a flowchart illustrating operations performed by the terminal adapter 220 of the data transfer system 200 for data transfer.

FIG. 9 is a flowchart illustrating operations performed by the server 210 of the data transfer system 200 for the data transfer.

FIG. 10 illustrates a data transfer system 300 according to Example 3 of the present invention.

FIG. 11 is a flowchart illustrating operations performed by a wireless terminal adapter 327 of the data transfer system 300 for the data transfer.

### DESCRIPTION OF THE PREFERRED EMBODIMENTS

Hereinafter, embodiments of the present invention will be described with reference to drawings.

### EXAMPLE 1

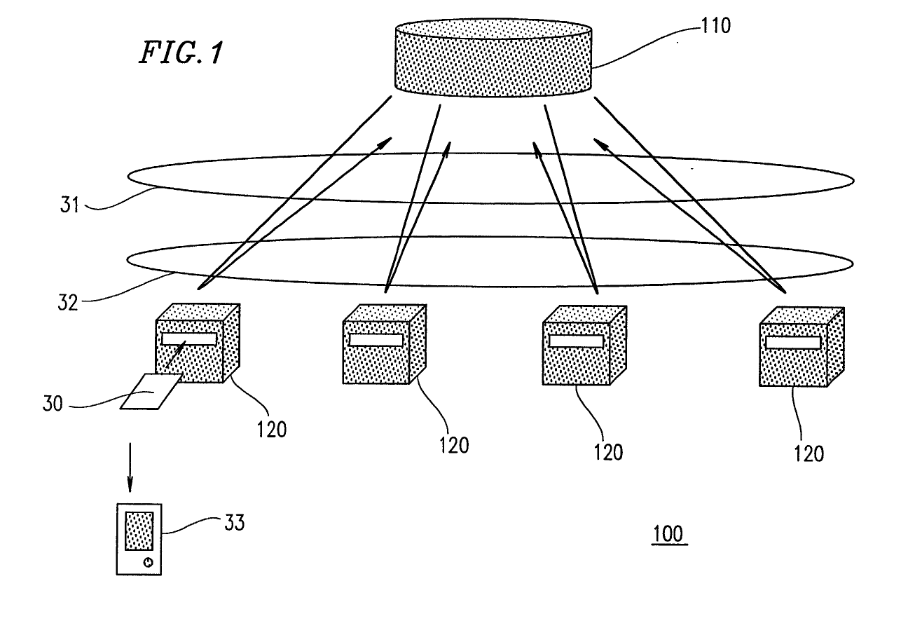

FIG. 1 illustrates a configuration of a data transfer system 100 according to Example 1 of the present invention. The data transfer system 100 includes a server 110 and at least one terminal adapter (TA) 120 (four are shown in FIG. 1) interconnected to the server 110 through the Internet 31 and a telephone line 32. The server 110 is, for example, provided for a collection and delivery center which performs collection and delivery of data. Each terminal adapter 120 is provided for a home or the like and is connected to the Internet 31 through the telephone line 32. The terminal adapter 120 has a removable recording medium 30, such as a memory cartridge, a memory card, or the like. The removable recording media 30 can be used with a data input/output device 33 having a data input/output function. The data input/output device 33 can be, for example, a portable game machine, an audio or visual device, an information communication device, or an interactive remote control.

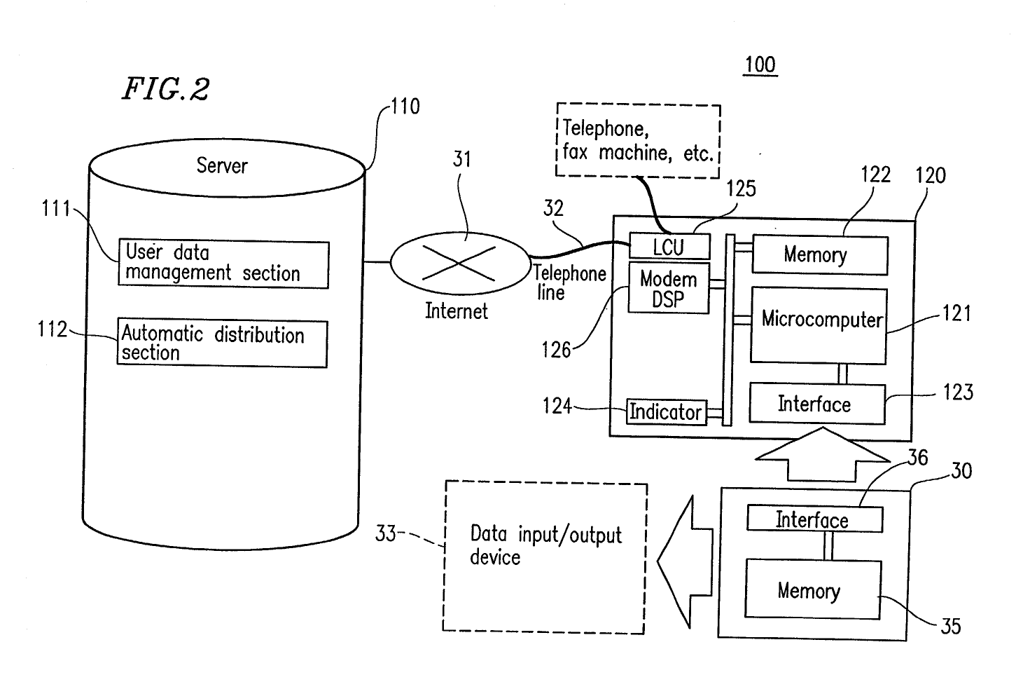

FIG. 2 illustrates the configuration of the data transfer system 100 according to Example 1 of the present invention in more detail. The server 110 has a user data management section 111 and an automatic distribution section 112. The user data management section 111 manages, for example, a telephone number of the telephone line 32 which is an address of each terminal adapter 120 (only one is shown in FIG. 2 for convenience) connected to the server 110 through the Internet 31 and the telephone line 32; and/or a user ID for use in identification of a user of the terminal adapter 120. The automatic distribution section 112 automatically distributes data to each terminal adapter 120 based on a schedule of preset dialing times.

The terminal adapter 120 includes a microcomputer 121, a memory 122, an interface 123, an indicator 124, an LCU 125, and a modem (DSP) 126.

The microcomputer 121 controls the memory 122, the interface 123, the indicator 124 and the modem 126.

The memory 122 stores, for example, data pertaining to a user ID for specifying a user who uses the terminal adapter 120.

The interface 123 is provided for connecting the terminal adapter 120 to the recording media 30.

The indicator 124 is, for example, an LED which indicates that data has been sent from the server 110 to the terminal adapter 120 when lit.

The LCU 125 can be connected to a telephone, a fax machine, etc.

The modem 126 is connected to the telephone line 32 through the LCU 125.

The recording media 30 includes an interface 36 and a memory 35 for storing data.

The interface 36 is connected to the interface 123 of the terminal adapter 120. The memory 35 is connected to the interface 36.

The terminal adapter 120 detects that the recording media 30 is mounted thereon. For example, when the recording medium 30 is mounted on the terminal adapter 20 and the interface 36 is electrically connected to the interface 123, a prescribed signal is output to the microcomputer 121. Alternatively, the terminal adapter 120 may output the prescribed signal to the microcomputer 121 when the mounting of the recording medium 30 is mechanically detected.

Hereinafter, center polling which is performed by the server 110 to the terminal adapters 120 in the data transfer system 100 having the above configuration will be described.

In the data transfer system 100 according to Example 1 of the present invention, the terminal adapter 120 detects the mounting and dismounting of the recording medium 30 and transfers data between the server 110 and the terminal adapter 120.

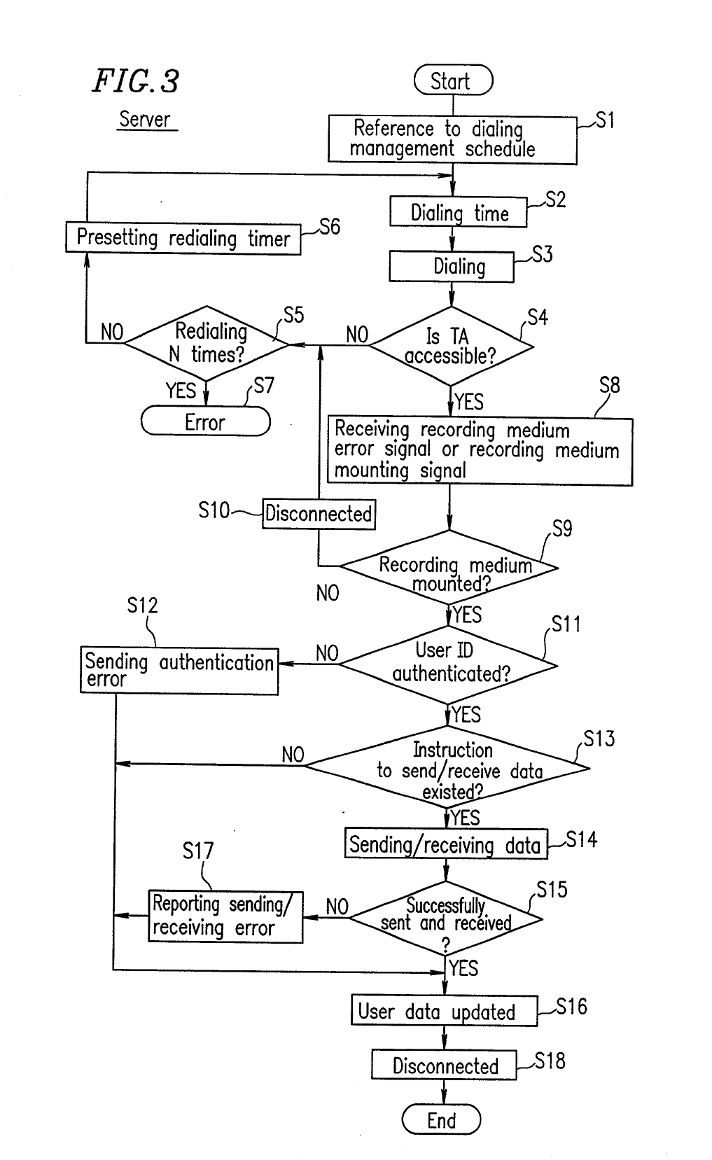

FIG. 3 illustrates operations performed by the server 110 of the data transfer system 100 for the center polling. The server 110 performs steps S1-S18 of FIG. 3.

The server 110 makes reference to a dialing management time schedule provided to the automatic distribution section 112 (step S1). When a dialing time which is preset in the dialing management time schedule occurs (step S2), the server 110 automatically dials a telephone number which is an address of a terminal adapter 120 in order to access the terminal adapter 120 (step S3).

The telephone number for accessing the terminal adapter 120 is pre-registered with the server 110 as an ID specific to the recording medium 30 which is mounted on the terminal adapter 120.

The server 110 determines whether or not the prescribed terminal adapter (TA) 120 is accessible (step S4). If it is not accessible, the server 110 redials the telephone number corresponding to the terminal adapter 120 prescribed number (N) of times so as to access the terminal adapter 120 (step S5). For redialing the telephone number, the time interval for redialing may be arbitrarily preset with a timer (step S6). In such a case, when a preset redialing time occurs (step S2), the telephone number is redialed (step S3). When the server 110 cannot access the prescribed terminal adapter 120 after repeating the redialing N times, the server 110 recognizes an error and ends the control of redialing. (step S7).

When the server 110 receives a recording medium mounting signal from the terminal adapter 120 (step S8), the server 110 determines whether or not the recording medium 30 is mounted on the terminal adapter 120 (step S9). When the server 110 receives a recording medium error signal from the terminal adapter 120 (step S8), the server 110 determines that the recording medium 30 is not mounted on the terminal adapter 120 (step S9). When it is determined that the recording medium 30 is not mounted on the terminal adapter 120, the server 110 disconnects the terminal adapter 120 from the telephone line (step S5), and thereafter, the server 110 redials the telephone number of the terminal adapter 120 N times (step S5).

When the server 110 determines that the recording medium 30 is mounted on the terminal adapter 120 (step S9), the server 110 performs authentication of a user ID in the case where the terminal adapter 120 has a user ID (step S11).

When the user ID of the terminal adapter 120 is not identical to the user ID which is pre-registered with the user data management section 111 of the server 110, the server 110 sends an authentication error to the terminal adapter 120 (step S12). The server 110 updates the user data managed by the user data management section 111 and records the time of access to the prescribed terminal adapter 120, a failure in an user ID authentication and the like (step S16).

When the user ID of the terminal adapter 120 is authenticated, the server 110 determines: (i) whether or not there is an instruction in the server 110 for sending data to the terminal adapter 120; and (ii) whether or not there is an instruction in the terminal adapter 120 for sending data to the server 110 (step S13). When the server 110 has data to be sent to the terminal adapter 120, the server 110 sends the data to the terminal adapter 120. When the terminal adapter 120 has data to be sent to the server 110, the terminal adapter 120 sends the data to the server 110 (step S14).

Thereafter, the server 110 determines that the data is successfully sent and received (step S15). The server 110 updates the user data managed by the user data management section 111 and records the time of access to the prescribed terminal adapter 120, a success in sending and/or receiving (hereinafter, indicated as “sending/receiving”) of data and the like (step S16).

When the data is not successfully sent or received, the server 110 reports to the terminal adapter 120 of a sending/receiving error (step S17). The server 110 updates the user data managed by the user data management section 111 and records the time of access to the prescribed terminal adapter 120, or an error in sending/receiving of data (step S16).

When the user data which is recorded by the user data management section 111 is updated, the server 110 disconnects the terminal adapter 120 from the telephone line 32 so as to end the control operation (step S18).

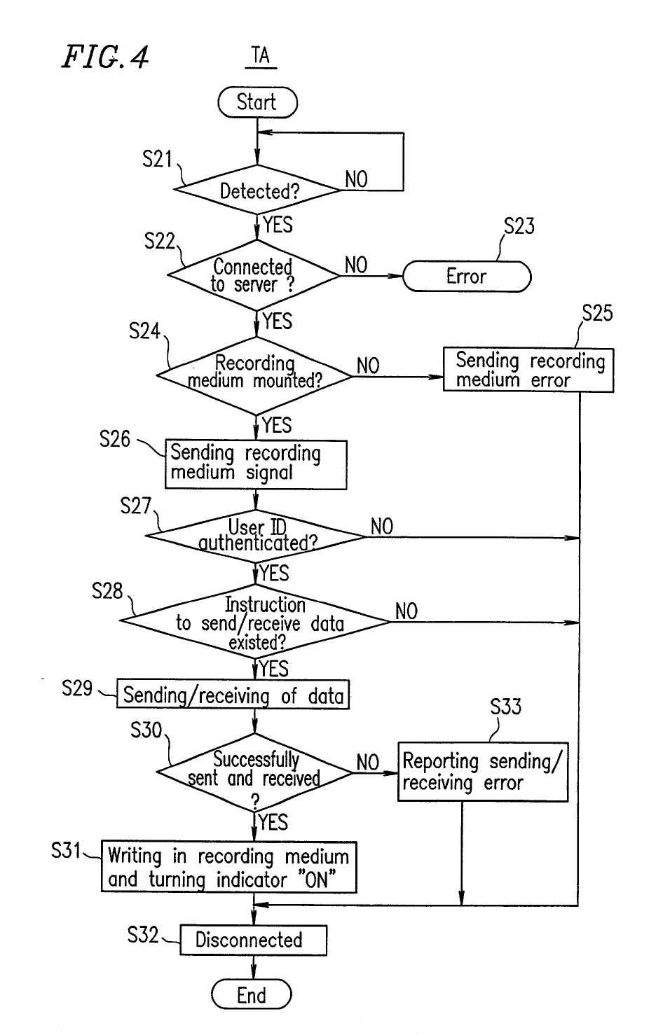

FIG. 4 illustrates operations performed by the terminal adapter 120 of the data transfer system 100 for the center polling.

When the server 110 accesses a prescribed terminal adapter 120, the terminal adapter 120 performs the steps S21 to S33 shown in FIG. 4.

When the terminal adapter 120 detects the dialing of a telephone number from the server 110 (step S21), the terminal adapter 120 determines whether or not the server 110 is connected thereto (step S22). When the terminal adapter 120 is not connected to the server 110, the terminal adapter 120 ends the control operation (step S23).

When it is determined that the terminal adapter 120 is connected to the server 110, the terminal adapter 120 determines whether or not the recording medium 30 is mounted on the terminal adapter 120 (step S24). When the recording medium 30 is not mounted on the terminal adapter 120, the terminal adapter 120 sends a recording medium error signal to the server 110 (step S25), and the terminal adapter 120 is kept on hold until the server 110 disconnects itself from the telephone line 32.

When the recording medium 30 is mounted on the terminal adapter 120, the terminal adapter 120 sends to the server 110 a recording medium mounting signal which indicates that the recording medium 30 is mounted (step S26).

The terminal adapter 120 determines whether or not the user ID is authenticated depending on whether an authentication error is sent from the server 110 or not (step S27). When the terminal adapter 120 authenticates the user ID, the terminal adapter 120 determines: (i) whether or not there is an instruction in the memory 35 of the recording medium 30 for sending data to the server 110: and (ii) whether or not there is an instruction in the server 110 for sending data to the terminal adapter 120 (step S28).

When there is data in the memory 35 of the recording medium 30 to be sent to the server 110, the terminal adapter 120 reads the data from the memory 35 of the recording medium 30 and sends it to the server 110. When there is data in the server 110 to be sent to the terminal adapter 120, the terminal adapter 120 receives the data from the server 110 (step S29).

Thereafter, the terminal adapter 120 determines that sending/receiving of the data is successfully performed (step S30), the terminal adapter 120 writes the received data in the memory 35 of the recording medium 30 and turns on the indicator 124 (step S31). Next, the terminal adapter 120 is disconnected from the telephone line 32 by the server 110 (step S32).

When the data is not successfully sent or received, the terminal adapter 120 reports the sending/receiving error to the server 110 (step S33). After the user data is updated by the server 110 (step S16 of FIG. 3), the terminal adapter 120 is disconnected from the telephone line 32 by the server 110 (step S32).

When the indicator 124 of the terminal adapter 120 is on, a user of the terminal adapter 120 can determine that the data has already been sent from the server 110. When the user determines that data has already been sent from the server 110, the user mounts the recording medium 30, which is removed from the terminal adapter 120, on the input/output device 33 so as to read the data stored on the memory 35 which was sent from the server 110.

For sending the data stored in the input/output device 33 to the server 110, the user mounts the recording medium 30 on the input/output device 33 so as to write the data of the input/output device 33 in the memory 35 of the record medium 30. Next, the user mounts the recording medium 30 on the terminal adapter 120. When the data is sent from the server 110 to the terminal adapter 120 at a dialing time, the server 110 reads the data of the input/output device 33 from the memory 35 of the recording medium 30 mounted on the terminal adapter 120 and receives the data of the input/output device 30 from the terminal adapter 120.

Accordingly, in either case, the sending/receiving of data is only instructed by mounting the recording medium 30 on the terminal adapter 120. Therefore, the data is automatically sent and received between the server 110 and the terminal adapter 120 without requiring a user's operation of connecting the terminal adapter 120 to the telephone line 32.

In Example 1, the dialing management time schedule which is provided in the user data management section 111 of the server 110 is appropriately changed at a prescribed time, e.g., each week, each month, etc. The dialing management time schedule may be changed based on the user data recorded in the user data management section 111, such that a dialing time for each of the terminal adapters 120 can be spread in a time slot when data traffic to and from the server 110 is low. When the dialing times to the terminal adapters 120 are spread, the traffic to and from the server 110 is spread when sending and receiving data. When the dialing time is set in a time slot when charges for use of the telephone line 32 are low, telephone charges to the user can be decreased.

The data which can be sent from the server 110 to the terminal adapters 120 is not limited to any specific data. For example, when the recording medium 30 is an exclusive cartridge for a portable computer game provided as the data input/output device 33, data regarding contents of the portable computer game is sent. A variety of data may be sent depending on the age group, favorites, or the like of the user.

For example, when the user of the portable computer game mounts the game cartridge provided as the recording medium 30 on the terminal adapter 120, the server 110 may recognize that the recording medium 30, which is mounted on the terminal adapter 120, is the game cartridge, and may send data regarding characters of the game, data regarding the game, or the like. In such a case, the sent data is stored in the game cartridge.

Moreover, the server 110 may be an e-mail server over the Internet.

For example, in the case where a plurality of terminal adapters 120 are connected to an e-mail server as the server 110, when the recording medium 30 storing a prescribed e-mail address and e-mail is mounted on one of the terminal adapters 120, the server 110 reads the e-mail address and sends an e-mail to the terminal adapter 120 associated with the e-mail address. In such a case, a recording medium 30 is required to be mounted on the terminal adapter 120 to which the mail is sent.

Moreover, a message can be sent from the server 110 to a designated terminal adapter 120 based on the pre-registered user data. For example, in the case where a birthday of the user is registered with the server 110, when a message for the birthday is preset to be sent from the server 110 to the terminal adapter 120 of the user, the birthday message is sent to the terminal adapter 120 on the user's birthday. The message is recorded on the recording medium 30 mounted on the terminal adapter 120 of the user.

### EXAMPLE 2

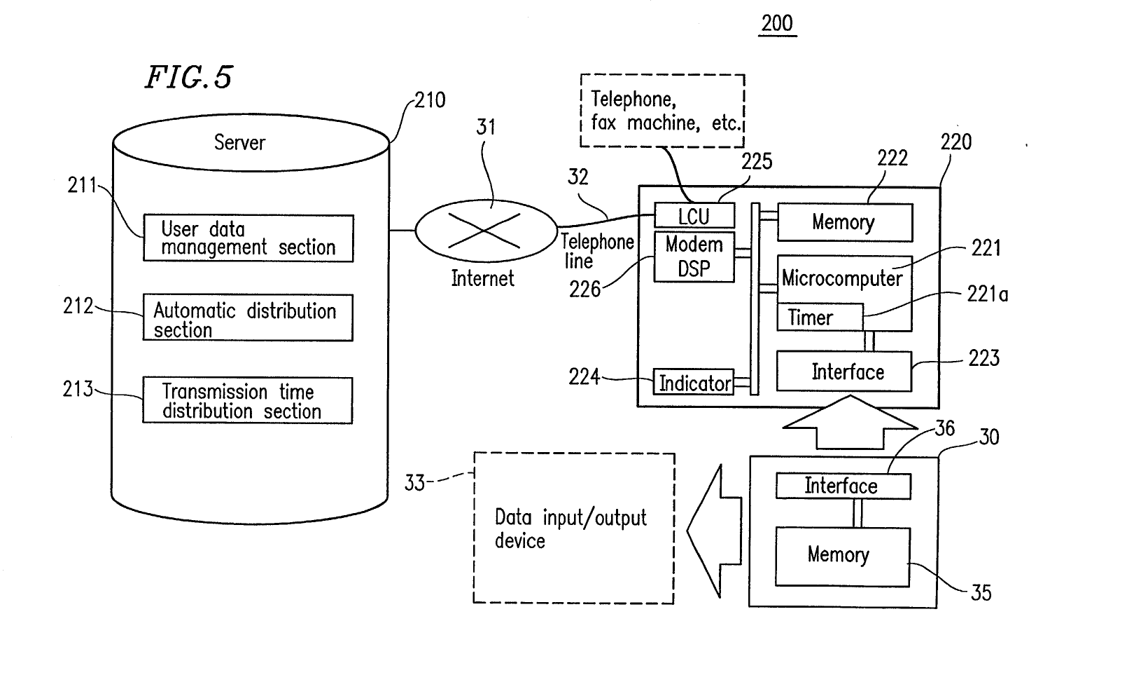

FIG. 5 illustrates a configuration of a data transfer system 200 according to Example 2 of the present invention.

A configuration of the server 210 is the same as that of the server 110 of Example 1 except that a dialing time distribution section 213 is provided in the server 210.

The dialing time distribution section 213 allocates a dialing time when each terminal adapter 220 transmits data to each terminal adapter 220.

A configuration of the terminal adapter 220 is the same as that of the terminal adapter 120 of Example 1 except that a timer 221a is provided within a microcomputer 221 of the terminal adapter 220.

A configuration of the recording medium 30 is the same as that of the recording medium 30 of Example 1.

Hereinafter, an automatic dialing to the server 210 performed by the terminal adapters 220 in the data transfer system 200 having such a configuration will be described.

In the data transfer system 200 according to Example 2 of the present invention, when the terminal adapter 220 initially accesses the server 210, the dialing time schedule is sent from the server 210 to the terminal adapter 220 so as to be registered therewith. After the dialing time schedule is registered, data is transferred between the server 210 and the terminal adapter 220.

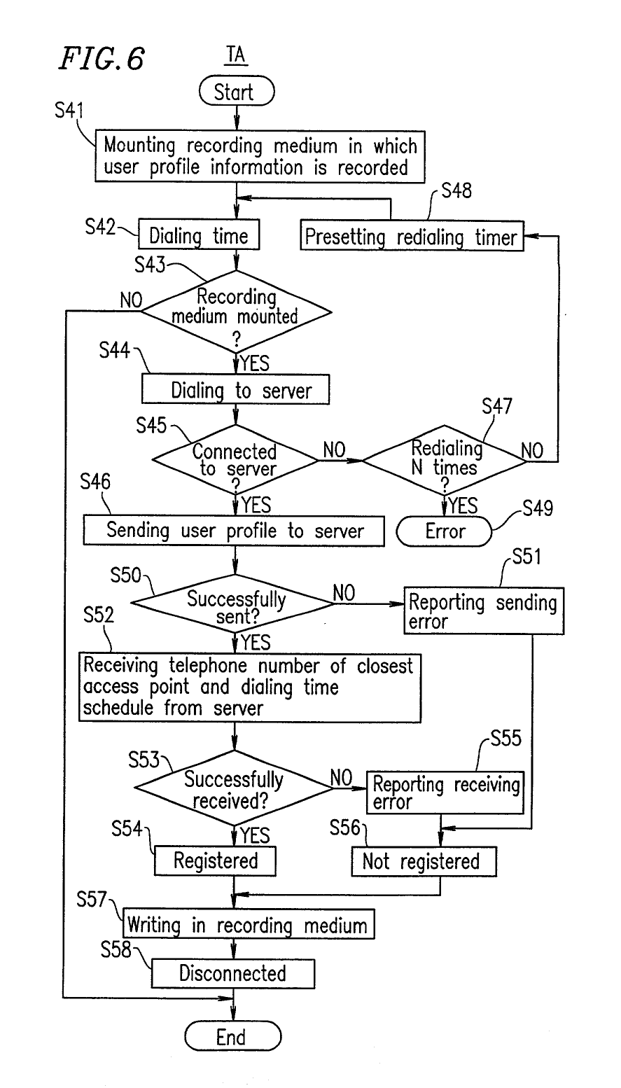

FIG. 6 illustrates operations performed by the terminal adapter 220 of the data transfer system 200 for the dialing time schedule registration. The terminal adapter 220 performs steps S41-S58.

In the memory 222 of the terminal adapter 220, a dialing time at which the terminal adapter 220 is to access a prescribed server 210 is preset. For accessing the server 210, the user pre-records user profile data on the recording medium 30 to be mounted on the terminal adapter 220. The user profile data includes, for example, a name, age and telephone number of the user, and other data associated with attributes of the user. As already mentioned, the server 210 has a pre-registered user ID which is specific to the recording medium 30 to be mounted on the terminal adapter 220.

A user mounts the recording medium 30 storing user profile information on the terminal adapter 220 (step S41). When the preset prescribed dialing time occurs (step S42), the terminal adapter 220 determines whether or not the recording medium 30 registering the user profile data therewith is mounted thereon (step S43). When the terminal adapter 220 is not mounted, the terminal adapter 220 ends the control operation.

When the terminal adapter 220 determines that the recording medium 30 is mounted thereon (step S43), the terminal adapter 220 automatically accesses the telephone line 32 connected to the prescribed server 210 (step S44). The telephone number of the telephone line 32 has been registered at the time of shipping or sale of the terminal adapter 220.

When the terminal adapter 220 determines that the server 210 is connected thereto (step S45), the user profile data recorded on the recording medium 30 is sent to the server 210 along with the user ID (step S46).

When the terminal adapter 220 cannot access the server 210 (step S45), the terminal adapter 220 redials the telephone number corresponding to the terminal adapter 220 a prescribed number (N) of times so as to access the server 210 (step S47). For redialing the telephone number, a time interval for redialing may be arbitrarily preset with a timer (step S48). In such a case, when a preset dialing time occurs (step S42), the terminal adapter 220 determines whether or not the recording medium 30 is mounted thereon (step S43), if it is mounted, the telephone number is redialed. When access to the terminal adapter 220 can not access the server 210 after repeating the redialing N times, the terminal adapter 220 recognizes an access error and ends the control of the terminal adapter 220 (step S49).

When the user profile data recorded on the recording medium 30 is sent to the server 210 along with the user ID (step S46), the terminal adapter 220 determines whether or not the user profile data is successfully sent to the server 210 (step S50). When the user profile data is not successfully sent, the terminal adapter 220 reports a sending error to the server 210 (step S51). When the sending error is reported to the server 210, the server 210 records for each user ID that the telephone number of the access point and the dialing time schedule are not registered with the terminal adapter 220 (step S56). Moreover, the server 210 records for each user ID that the telephone number of the access point and the dialing time schedule are not registered with the memory 35 of the recording medium 30 (step S57).

The following is not illustrated in FIG. 6. When the server 210 performs the authentication of the user ID which is sent thereto and the sent user ID is not identical to the pre-registered user ID, the server 210 reports an authentication error to the terminal adapter 220 and records for each user ID that the telephone number of the access point and the dialing time schedule are not registered with the terminal adapter 220 or with the memory 35 of the recording medium 30.

Referring again to FIG. 6, when the user profile data is successfully sent, the terminal adapter 220 receives the telephone number of the closest access point and dialing time schedule which are sent from the server 210 (step S52). The terminal adapter 220 determines whether or not the telephone number of the closest access point and dialing time schedule are successfully received (step S53). When the data is successfully received, the terminal adapter 220 registers the telephone number of the access point and the dialing time schedule with the memory 222 of the terminal adapter 220 (step S54). The terminal adapter 220 writes the telephone number of the access point and the dialing time schedule in the memory 35 of the recording medium 30 mounted thereon (step S57).

When the telephone number of the closest access point and the dialing time schedule sent from the server 210 are not successfully received, the terminal adapter 220 reports an error to the server 210 (step S55), and records on the corresponding memory 222 that the telephone number of the access point and the dialing time schedule are not registered (step S56). Next, the terminal adapter 220 writes in the memory 35 of the recording medium 30 mounted thereon that registration is incomplete (step S57). Thereafter, the terminal adapter 220 disconnects itself from the telephone line (step S58).

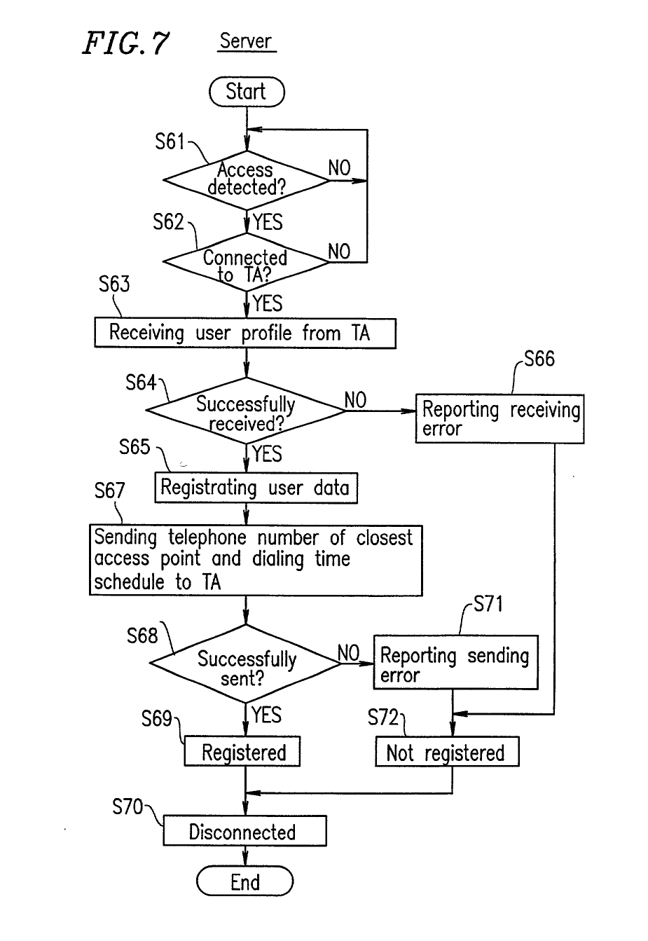

FIG. 7 illustrates operations performed by the server 210 of the data transfer system 200 for the dialing time schedule registration. The server 210 performs steps S61-S72.

When access from the terminal adapter 220 is detected (step 61), the server 210 determines that the terminal adapter 220 is connected thereto through the telephone line 32 (step S62), and receives the user profile data sent from the terminal adapter 220 (step S63).

Thereafter, the server 210 determines whether or not the user profile data is successfully received by the server 210 (step S64). When the user profile data is successfully received, the server 210 registers the received user profile data for each user ID which is pre-registered with the user data management section 211 (step S65). When the user profile data is not successfully received, the server 210 reports a receiving error to the terminal adapter 220 (step S66).

When the user profile data is registered with the user data management section 211 (step S65), the server 210 sends to the terminal adapter 220 the telephone number provided as an address for accessing a server 210 closest to the terminal adapter 220. At the same time, the server 210 selects an appropriate dialing time which is preset by the dialing time schedule management section 213 and sends it to the terminal adapter 220 (step S67). When the server 210 determines that the data is successfully sent to the terminal adapter 220 (step S68), the telephone number and dialing time schedule which is sent to the terminal adapter 220 are registered for each user ID which is pre-registered with the user data management section 211 (step S69). Thereafter, the server 210 disconnects itself from the telephone line (step S70).

When the telephone number of the closest access point and the dialing time schedule are not successfully sent to the terminal adapter 220 (step S68), a sending error is reported to the terminal adapter 220 (step S71), and the user data management section 211 records the incomplete registration of the telephone number of the access point and the dialing time schedule (step S72). Thereafter, the server 210 disconnects itself from the telephone line (step S70).

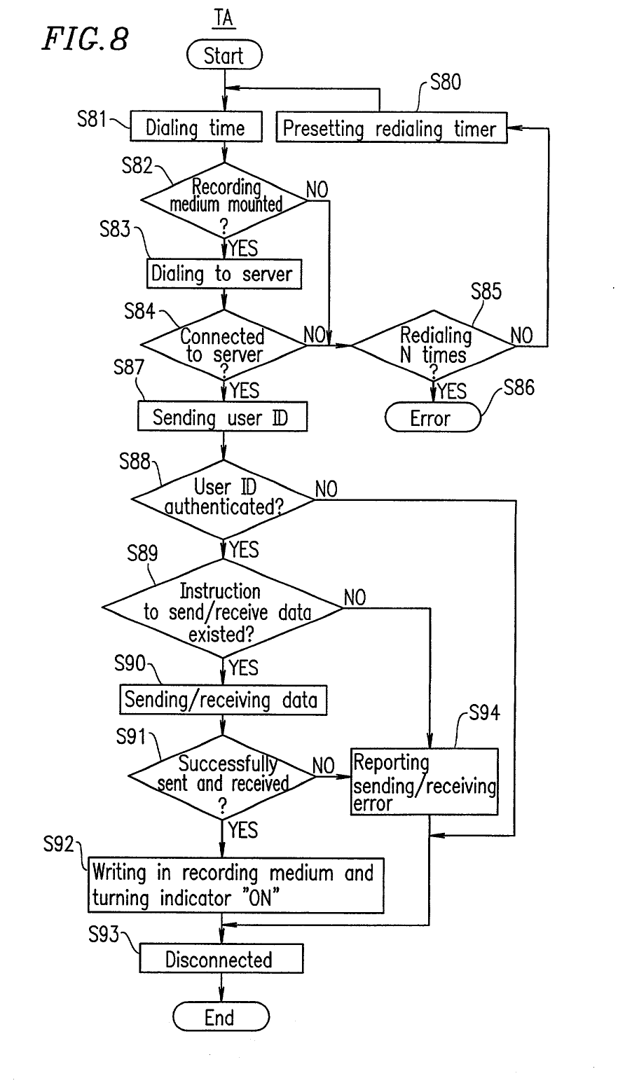

FIG. 8 illustrates operations performed by the terminal adapter 220 of the data transfer system 200 for data transfer. The terminal adapter 220 performs the steps S81-S94.

When the telephone number of the closest access point and the dialing time schedule are registered with the terminal adapter 220, the terminal adapter 220 accesses the server 210 based on the dialing schedule registered therewith, so that data transfer between the terminal adapter 220 and the server 210 is performed.

The dialing time is recorded on the terminal adapter 220 by the first access to the prescribed server 210. When a timer 221a provided for the microcomputer 221 determines that the dialing time occurs (step 81), the terminal adapter 220 determines whether or not the recording medium 30 is mounted thereon (step S82).

When the recording medium 30 is not mounted on the terminal adapter 220, the terminal adapter 220 redials the telephone number of the server 210 N times so as to access the server 210 (step S85). For redialing the telephone number, a time interval for redialing is preset by the timer 221a of the terminal adapter 220 (step S80). When the dialing time occurs, the terminal adapter 220 redials the telephone number so as to access the server 210. When the terminal adapter 220 cannot access the server 210 after repeating the redialing N times, the terminal adapter 220 recognizes an error and terminates access to the server 210 (step S86).

When the recording medium 30 is mounted on the terminal adapter 220, the terminal adapter 220 automatically dials the telephone number which is registered therewith so as to access the server 210 of the access point (step S83).

Next, the terminal adapter 220 determines whether or not the server 210 is accessible (step S84). When the terminal adapter 220 cannot access the server 210, the terminal adapter 220 redials the telephone number of the server 210 N times so as to access the server 210 (step S85). For redialing the telephone number, a time interval for redialing is preset by the timer 221a of the terminal adapter 220 (step S80). When the dialing time occurs, the terminal adapter 220 redials the telephone number so as to access the server 210. When the terminal adapter 220 cannot access the server 210 after repeating the redialing N times, the terminal adapter 220 recognizes an error and terminates access to the server 210 (step S86).

When the terminal adapter 220 determines that the terminal adapter 220 is connected to the server 210 (step S84), the terminal adapter 220 sends a user ID of the recording medium 30 to the server 210 (step S87).

The terminal adapter 220 determines whether or not there is authentication of an user ID by depending on whether an authentication error is sent from the server 210 or not (step S88). When the user ID is authenticated, the terminal adapter 220 determines: (i) whether or not there is an instruction in the recording medium 30 for sending data to the server 210; and (ii) whether or not there is an instruction in the server 210 for sending data to the terminal adapter 220 (step S89).

When it is determined that there is data to be sent in the recording medium 30 from the terminal adapter 220 to the server 210, the terminal adapter 220 reads the data from the memory 35 of the recording medium 30, and that there is data in the server 210 to be sent from the server 210 to the terminal adapter 220, the data is sent and received. (step S90).

Thereafter, the terminal adapter 220 determines whether or not the data is successfully sent and received (step S91). When the data is successfully sent and received, the terminal adapter 220 writes the received data in the memory 35 of recording medium 30 and turns on an indicator 224 (step S92). Thereafter, the terminal adapter 220 disconnects itself from the telephone line 32 (step S93).

When the data is not successfully sent or received (step S91), a sending/receiving error is reported to the server 210 (step S94). Thereafter, the terminal adapter 220 disconnects itself from the telephone line 32 (step S93).

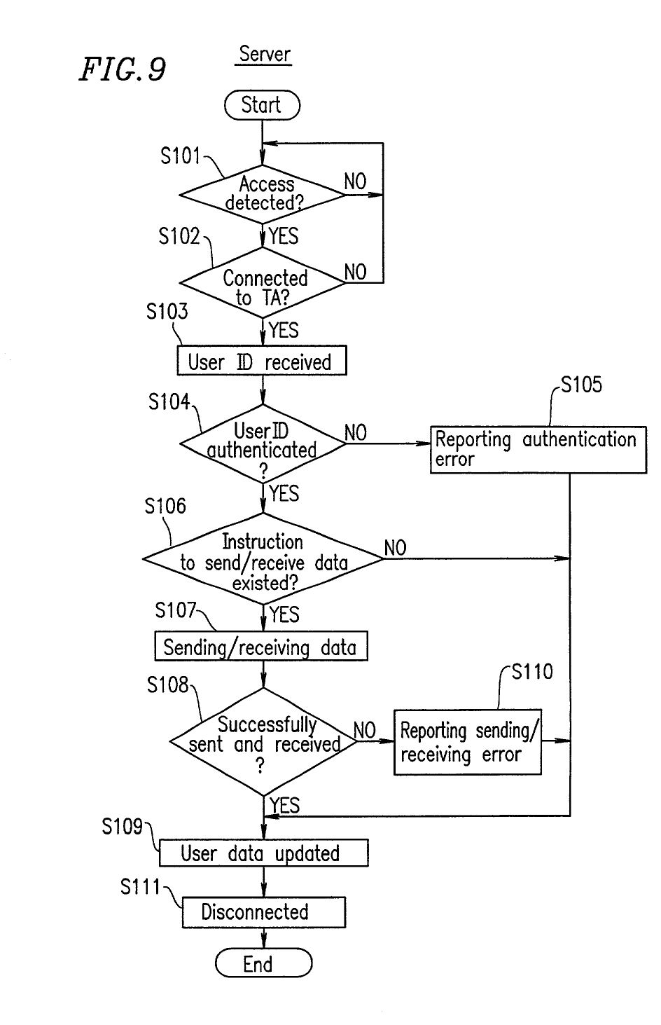

FIG. 9 illustrates operations performed by the server 210 of the data transfer system 200 for data transfer. The server 210 performs the steps S101-S111.

The server 210 determines whether or not there is an access by the terminal adapter 220 (step S101). When access is determined, the server 210 determines whether or not the terminal adapter 220 is connected thereto through the telephone line 32 (step S102). When it is determined that the terminal adapter 220 is connected, the server 210 receives a user ID of the recording medium 30 sent from the terminal adapter 220 (step S103) and performs an authentication of the received user ID (step S104).

When the user ID of the terminal adapter 220 is not identical to the user ID which is pre-registered with the user data management section 211 of the server 210, the server 210 reports an authentication error to the terminal adapter 220 (step S105). The server 210 updates the user data managed by the user data management section 211 and records the time of access by the terminal adapter 220, a failure in an user ID authentication and the like (step S109).

When the user ID of the terminal adapter 220 is identical to the user ID which is pre-registered with the user data management section 211 of the server 210, the server 210 determines: (i) whether or not there is an instruction in the server 210 for sending data to the terminal adapter 220; and (ii) whether or not there is an instruction in the terminal adapter 220 for sending data to the server 210 (step S106). When it is determined that there is data to be sent in the recording medium 30 from the terminal adapter 220 to the server 210, and that there is data in the server 210 to be sent from the server 210 to the terminal adapter 220, the data is sent and received. (step S107).

Thereafter, the server 210 determines whether or not the data is successfully sent and received (step S108). When the data is successfully sent and received, the server 210 updates the user data managed by the user data management section 211 and records the time of access by the terminal adapter 220, a success in the sending/receiving of the data and the like on the user ID (step S109).

When the data is not successfully sent or received, the server 210 reports a sending/receiving error to the terminal adapter 220 (step S110). The server 210 updates the user data managed by the user data management section 211 and records the time of access to the prescribed terminal adapter 220, a failure in the sending/receiving of the data and the like (step S109).

When the user data of the user data management section 211 is updated, the terminal adapter 220 disconnects itself from the telephone line 32 (step S111) and the server 210 ends the control operation.

As in the case of the data transfer system 100, the sending/receiving of data is only instructed by mounting the recording medium 30 on the terminal adapter 220 in the data transfer system 200. Therefore, the data is automatically sent and received between the server 210 and the terminal adapter 220 without requiring a user's operation of connecting the terminal adapter 220 to the telephone line 32.

In Example 2, the dialing time schedule of the terminal adapter 220 is distributed and preset by the first access of the terminal adapter 220 to the prescribed server 210. The dialing time schedule may be preset on the memory 222 of the terminal adapter 220 at the time of the shipping or sale of the terminal adapter 220. A plurality of different dialing times may be automatically preset for each terminal adapter 220 by providing a function for randomly presetting the dialing time for each terminal adapter 220.

The dialing time may be appropriately changed. As described above, the dialing time of the terminal adapter 220 may be spread in a time slot when traffic to the server 210 is low. The number of dialing times may be limited to, for example, twice a day.

### EXAMPLE 3

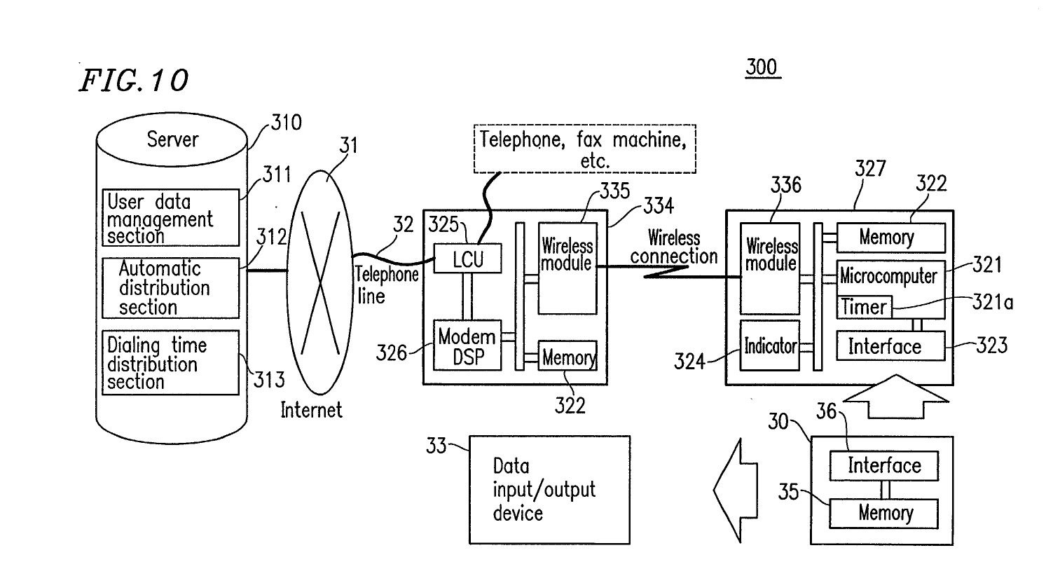

FIG. 10 illustrates a configuration of a data transfer system 300 according to Example 3 of the present invention. The configuration of the data transfer system 300 is the same as that of the data transfer system 200 of Example 2 except that wireless terminal adapters 327 and a wireless connection adapter unit 334 are provided in the data transfer system 300 instead of the terminal adapter 220.

Each wireless terminal adapter 327 includes a microcomputer 321, a timer 321a, a memory 322, an interface 323, an indicator 324, and a wireless module 336.

The wireless connection adapter unit 334 includes a memory 322, an LCU 325, a modem (DSP) 326, and a wireless module 335.

The respective functions of the microcomputer 321, the timer 321a, the memory 322, the interface 323, the indicator 324, the LCU 325, and the modem (DSP) 326, wireless connection adapter unit 334, the memory 322, the LCU 325 are the same as those of the microcomputer 221, the timer 221a, the memory 222, the interface 223, the indicator 224, the LCU 225, and the modem (DSP) 226 of Example 2.

The wireless module 335 and the wireless module 336 are connected to each other through a wireless connection.

The connection between the wireless module 335 and the wireless module 336 is realized by using bluetooth, IR, wireless LAN, IEEE1394Wireless, or the like.

Hereinafter, automatic dialing to the server 310 performed by the terminal adapters 327 in the data transfer system 300 having such a configuration will be described.

In the data transfer system 300 according to Example 3 of the present invention, when the wireless terminal adapter 327 initially accesses the server 310, a dialing time schedule is sent from the server 310 to the wireless terminal adapter 327 and registered therewith. When the dialing time schedule is registered, data is transferred between the server 310 and the wireless terminal adapter 327.

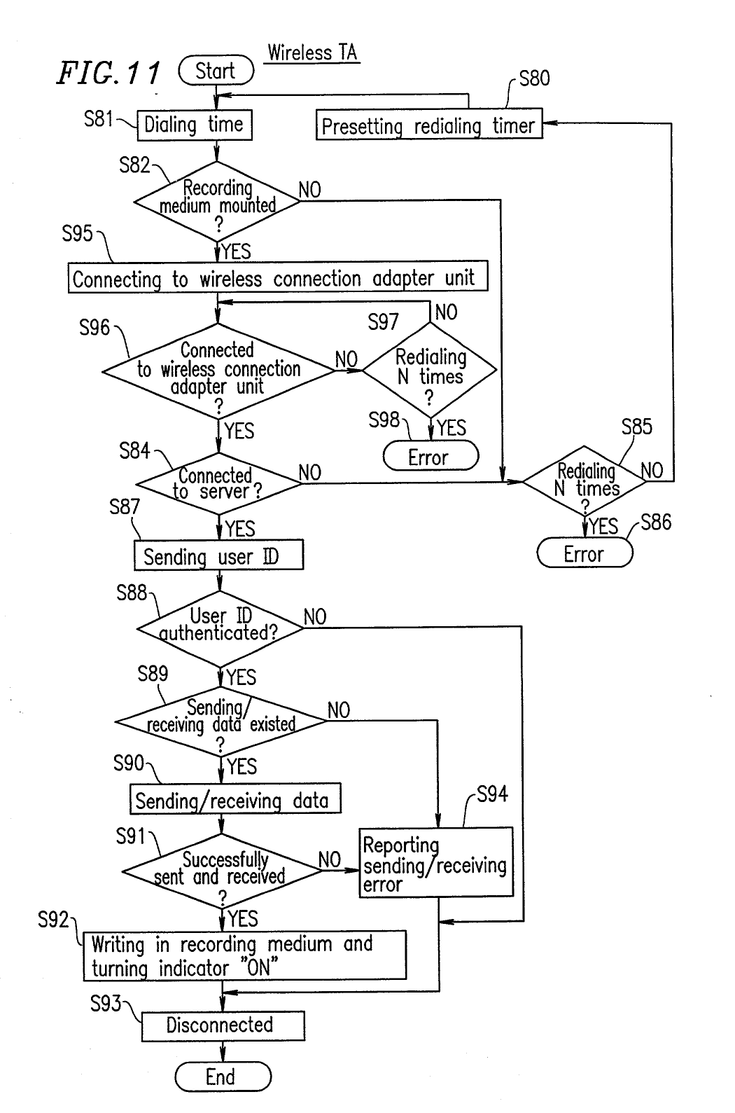

FIG. 11 illustrates operations performed by the terminal adapter 327 of the data transfer system 300 for data transfer. The wireless terminal adapter 327 operates steps S80-98. The data transfer operations performed by the wireless terminal adapter 327 are the same as those performed by the terminal adapter 220 shown in FIG. 8 except that steps S95-98 are performed by the wireless terminal adapter 327 in the data transfer system 300 instead of step S83 shown in FIG. 8.

Hereinafter, operations of the wireless terminal adapter 327 at steps S95-98 are specifically described.

The wireless terminal adapter 327 determines whether or not the recording medium 30 is mounted thereon (step S82). When the recording medium 30 is mounted on the wireless terminal adapter 327, the wireless module 336 of the wireless terminal adapter 327 is connected to the wireless module 335 of the wireless connection adapter unit 334 through a wireless connection (step S95). Next, the wireless terminal adapter 327 determines whether or not the wireless module 335 is connected to the wireless module 336 through wireless connection (step S96). The wireless connection is established between the wireless module 335 and the wireless module 336, and the wireless terminal adapter 327 determines whether or not the server 310 is accessible (step S84).

When the wireless connection is not established, the wireless terminal adapter 327 attempts to connect the wireless module 335 to the wireless module 336 a prescribed numbers (N) of times (step S97). In the case where the wireless connection of the wireless module 335 to the wireless module 336 is not established after N times, the wireless terminal adapter 327 recognizes the wireless connection of the wireless module 335 to the wireless module 336 as an error, and ends the connection control (step S98).

As described above, according to the data transfer system 300 of Example 3, the wireless terminal adapter 327 is provided with a wireless communication function, so that a user of the data transfer system 300 is provided with the service of the data transfer system anywhere in a home. Moreover, an indicator of the wireless terminal adapter allows the user to determine whether or not the data is sent and received anywhere within a home.

The wireless terminal adapter 327 is provided with the wireless communication function, therefore, in the case where the wireless terminal adapter 327 is used in the data transfer system 100 according to Example 1 or the data transfer system 200 according to Example 2, the wireless terminal adapter 327 can determine instructions in the wireless terminal adapter 327 for sending data to the server 310 or instructions in the server 310 for sending data to the terminal adapter 327 through wireless connection, thereby sending/receiving the data to and from the server 310.

The present invention is not limited to the configurations described in Examples 1-3. Any configuration for sending/receiving data based on mounting/dismounting of the recording medium 30 on/from the terminal adapter 120, the terminal adapter 220, or the wireless terminal adapter 327 may be used.

Moreover, procedures of data transform operations of the present invention may be recorded on a recording medium as a program or may be supplied to a server or terminal adapter through a network.

As described above, the data transfer system of the present invention can transfer data by using a mountable recording medium without sending/receiving operations performed by a user of a terminal adapter. Therefore, even a child, a user who is not accustomed to operate an electronic device, or the like can readily send and receive data. Particularly, data is sent and received only when the sending/receiving of data is instructed, so that even a child, for example, can use the data transfer system of the present invention without difficulty. Moreover, since the time for sending/receiving the data can be preset, traffic to and from the server can be equalized.

When the data transfer system of the present invention includes a wireless terminal adapter having a wireless communication function, a user is provided with the service of the data transform system anywhere within a home. In such a case, an indicator of the wireless terminal adapter allows the user to determine whether or not the data is sent and received anywhere within a home.

The server and terminal adapter of the present invention are suitable for the above-described data transfer system. Particularly, the terminal adapter is configured to record data on a recording medium which is mountable on the terminal adapter without including specific functions, such as viewing, listening, etc., of received data, and thus an extremely simple configuration can be achieved.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A data transfer system comprising a server and a terminal adapter capable of mutually transferring data to each other, wherein the server accesses the terminal adapter at a prescribed dialing time, and determines an instruction for sending first data to the terminal adapter and an instruction for receiving second data from the terminal adapter so as to send the first data to the terminal adapter and receive the second data from the terminal adapter.

2. A data transfer system according to claim 1, wherein the data transfer system allows a recording medium to be mountable thereon, and the instruction for sending the first data and the instruction for receiving the second data are issued based on whether the recording medium is mounted on the data transfer system or not.

3. A data transfer system according to claim 1, wherein the dialing time is preset based on a data traffic of the server.

4. A data transfer system comprising a server and a plurality of terminal adapters capable of transferring data to each other, wherein the server accesses each of the plurality of terminal adapters at a different dialing time preset for each of the plurality of terminal adapters, and determines an instruction for sending first data to each of the plurality of terminal adapters and an instruction for receiving second data from each of the plurality of terminal adapters so as to send the first data to each of the plurality of terminal adapters and receive the second data from each of the terminal adapters.

5. A data transfer system comprising a server and a terminal adapter capable of mutually transferring data to each other, wherein the terminal adapter accesses the server at a preset dialing time, and determines an instruction for sending first data to the server and an instruction for receiving second data from the server so as to send the first data to the server and receive the second data from the server.

6. A data transfer system according to claim 5, wherein the terminal adapter has a wireless communication function, and determines, through the wireless communication, an instruction for sending first data to the server and an instruction for receiving second data from the server so as to send the first data to the server and receive the second data from the server.

7. A terminal adapter capable of mutually transferring data to and from a server and allowing a recording medium to be mountable thereon, wherein the terminal adapter accesses the server at a preset dialing time based on whether the recording medium is mounted on the terminal adapter or not, and determines an instruction for sending first data to the server and an instruction for receiving second data from the server so as to send the first data to the server and receive the second data from the server.

8. A terminal adapter according to claim 7, wherein the terminal adapter has a wireless communication function, and determines, through the wireless communication, an instruction for sending first data to the server and an instruction for receiving second data from the server so as to send the first data to the server and receive the second data from the server.

9. A terminal adapter according to claim 7, wherein a dialing time and an address of the server are preset in the terminal adapter, and the terminal adapter accesses the server based on the preset dialing time and the preset address of the server.

10. A terminal adapter according to claim 7, wherein a dialing time and an address of the server are preset in the recording medium, and the terminal adapter accesses the server based on the preset dialing time and the preset address of the server.

11. A terminal adapter according to claim 7, wherein the dialing time is preset by accessing the server.

12. A terminal adapter according to claim 11, wherein an address of the server is preset so that the terminal adapter automatically accesses the server in which the dialing time is preset.

13. A server capable of mutually transferring data to and from a terminal adapter, wherein the server accesses the terminal adapter at a preset dialing time, and determines an instruction for sending first data to the terminal adapter and an instruction for receiving second data from the terminal adapter so as to send the first data to the terminal adapter and receive the second data from the terminal adapter.
